(19) United States
(12) Patent Application Publication
(10) Pub. No.: US 2012/0231641 A1
(43) Pub. Date: Sep. 13, 2012

(54) UNIT CELL CONNECTING DEVICE, ASSEMBLED BATTERY HAVING THE SAME, AND METHOD OF PRODUCING THE ASSEMBLED BATTERY

(76) Inventors: Katumi SUGAI, Aichi (JP); Takao Takasaki, Tokyo (JP); Tetuo Tukahara, Nagano (JP)

(21) Appl. No.: 13/478,797

(22) Filed: May 23, 2012

Related U.S. Application Data
(63) Continuation of application No. PCT/JP2010/071018, filed on Nov. 25, 2010.

(30) Foreign Application Priority Data
Nov. 27, 2009 (JP) 2009-269723

(51) Int. Cl. H01R 25/00; H01M 6/02

(52) U.S. Cl. 439/115; 29/623.1

(57) ABSTRACT

A unit cell connecting device is provided for connecting a plurality of unit cells (electric cells) arranged vertically and horizontally in rows such that positive electrodes (anodes) and negative electrodes (cathodes) thereof are aligned on same planes, respectively. The unit cell connecting device includes a plurality of inner connecting pieces and at least one outer connecting piece for connecting the inner connecting pieces. Each of the inner connecting pieces is configured to connect the positive electrodes and the negative electrodes of the electric cells. The outer connecting piece is configured to have a lead section formed at one end section thereof so as to protrude outwardly, so that the outer connecting piece is configured to connect a lead wire. As a result, it is possible to provide the unit cell connecting device resistant against a large current that flows in a high-capacity assembled battery.

### CROSS-REFERENCE TO RELATED APPLICATIONS

This is a continuation application of the prior PCT application PCT/JP2010/071018, filed on Nov. 25, 2010, pending, which claims priority from a Japanese patent application No. 2009-269723, filed on Nov. 27, 2009, the entire content of which is incorporated herein by reference.

### BACKGROUND OF THE INVENTION AND RELATED ART STATEMENT

The present invention relates to a unit cell connecting device, an assembled battery having the unit cell connecting device, and a method of producing the assembled battery. More specifically, the present invention relates to a unit cell connecting device and an assembled battery capable of improving large current resistance and heat dissipation.

In these years, electric cars have captured interests in view of environmental issues, and thereby there are increased demands for high-capacity assembled batteries to be used in such electric cars. For this reason, there has been proposed a conventional high capacity assembled battery. As the conventional high capacity assembled battery, an assembled battery is formed of electric cells (or unit cells) being connected in series or in parallel. For example, an electric cell unit is composed of a plurality of batteries connected together, or an electric cell module is composed of a plurality of such electric cell units connected together. Lastly, the assembled battery is incorporated in a container main body (a casing).

FIG. 10 is a perspective view showing a configuration of a conventional assembled battery and a method of producing the conventional assembled battery. As shown in FIG. 10, when the conventional assembled battery described above is produced, a plurality of electric cells 13 is vertically or horizontally arranged, so that anodes 13A thereof and cathodes (not illustrated) are arranged on same planes, respectively. Then, an electrode connecting piece 14 made of a flat plate is disposed along a side of the anodes 13A (and a side of the cathodes), so that the electrode connecting piece 14 connects the anodes 13A (and the cathodes) together, respectively. Furthermore, the electrode connecting piece 14 disposed on the side of the anode 13A is directly connected to the electrode connecting piece (not illustrated) on the side of the cathodes through lead wires 15 with soldering or other methods.

As described above, in the conventional assembled battery, the electrode connecting pieces 14 made of the relatively thin flat plate are directly connected through the lead wires 15 with soldering or other methods. Accordingly, it is difficult to flow a large current through the electrode connecting pieces 14 of the conventional assembled battery.

Further, in the conventional assembled battery, the electric cell unit is formed of a plurality of unit cells or the electric cell module is formed of a plurality of battery cells to achieve the high capacity. Accordingly, when the conventional assembled battery has a large size, heat generated within the unit cells tends to be accumulated upon charging and discharging thereof, thereby increasing an internal temperature of the unit cells. Therefore, it is imperative to efficiently dissipate the heat generated within the unit cells of the electric cell unit or the electric cell module.

As described above, however, in the conventional assembled battery, the electrode connecting pieces 14 are arranged adjacent to the anodes 13A and the cathodes of the electric cells 13. Accordingly, the electrode connecting pieces 14 are arranged to cover spaces between the electric cells 13 arranged vertically or horizontally adjacent to each other. As a result, an air flow between the electric cells 13 tends to be restricted, and the heat generated within the conventional assembled battery tends to be blocked. Accordingly, it is difficult to efficiently dissipate the heat generated within the conventional assembled battery, thereby resulting in poor cooling capability.
Patent Reference 1: Japanese Patent Publication No. 2003-151529
Patent Reference 2: Japanese Patent Publication No. 2003-331816
Patent Reference 3: Japanese Patent Publication No. 2004-111098

In view of the problems of the conventional assembled battery described above, an object of the present invention is to provide a unit cell connecting device, an assembled battery having the unit cell connecting device, and a method of producing the assembled battery capably of improving current resistance, heat dissipation, and cooling capability.

Further objects and advantages of the invention will be apparent from the following description of the invention.

### SUMMARY OF THE INVENTION

In order to attain the objects described above, the present invention is mainly characterized in an improvement in an electrode connecting configuration and a lead section configuration when an assembled battery is produced. Accordingly, it is possible to improve the high current resistance, the heat dissipation, the cooling capability, and so on.

According to a first aspect of the invention, a unit cell connecting device is provided for connecting a plurality of unit cells (electric cells) arranged vertically and horizontally in rows such that positive electrodes (anodes) and negative electrodes (cathodes) thereof are aligned on same planes, respectively.

According to the first aspect of the invention, the unit cell connecting device includes a plurality of inner connecting pieces and at least one outer connecting piece for connecting the inner connecting pieces. Each of the inner connecting pieces is configured to connect the positive electrodes and the negative electrodes of the electric cells. The outer connecting piece is configured to have a lead section formed at one end section thereof so as to protrude outwardly, so that the outer connecting piece is configured to connect a lead wire. As a result, it is possible to provide the unit cell connecting device resistant against a large current that flows in a high-capacity assembled battery.

In the first aspect of the invention, with the configuration described above, the inner connecting pieces are arranged such that spaces are formed between the inner connecting pieces, respectively. Further, spaces between the electrical cells arranged vertically or horizontally adjacent to each other are exposed outside, so that an air can easily flow through the spaces. In other words, an air flow therein is improved to promote heat dissipation. Accordingly, it is possible to efficiently dissipate heat generated inside the electric cells, and to improve the cooling capability.

According to a second aspect of the invention, the unit cell connecting device may further include a bridging piece extending along a securing position of the outer connecting piece for connecting the inner connecting pieces, so that the inner connecting pieces are integrated with the bridging piece. Accordingly, it is possible to provide the connecting configuration resistant against a large current, and to enhance the cooling capability. In addition, it is not necessary to produce many inner connecting pieces, thereby reducing the number of the components.

Moreover, in the second aspect of the invention, as opposed to the configuration in which a large number of inner connecting pieces are arranged individually, it is not necessary to incorporate each of the inner connecting pieces into the outer connecting piece, or it is not necessary to position each of the inner connecting pieces in relative to the outer connecting piece. Accordingly, it is possible to improve productivity.

According to a third aspect of the present invention, an unit cell connecting device is provided for connecting a plurality of electric cells arranged vertically and horizontally in rows such that positive electrodes (anodes) and negative electrodes (cathodes) thereof are aligned on same planes, respectively.

According to the third aspect of the invention, the unit cell connecting device includes one inner connecting piece made of a conductive material for electrically connecting the positive electrodes and the negative electrodes arranged on the same planes and more than one outer connecting piece made of a conductive material and connected to the inner connecting piece.

According to the third aspect of the invention, the inner connecting piece has a ventilation hole that is opened at a position corresponding to a space between the electric cells that are arranged adjacent to each other vertically and horizontally. Further, the outer connecting piece has a lead section at one end section thereof so as to protrude outwardly for connecting a lead wire. With the configuration, it is possible to provide the connecting configuration resistant against a large current that flows in a high-capacity assembled battery. Moreover, the ventilation hole is formed in the inner connecting piece as one sheet member simply through making the opening. Accordingly, it is possible to improve productivity as well as strength of the inner connecting piece.

In the unit cell connecting device according to the first aspect or the second aspect of the present invention, the inner connecting piece may include a groove in an inner portion thereof at a position corresponding to the space between the electric cells arranged adjacently, so that the outer connecting piece is accommodated in the groove. Accordingly, it is possible to clearly define a position where the outer connecting piece is attached to the inner connecting piece, thereby making it easy to position the outer connecting piece. At the same time, it is possible to tentatively attach the outer connecting piece to the inner connecting piece before the outer connecting piece is firmly attached to the inner connecting piece. Accordingly, it is possible to securely attach the outer connecting piece to the inner connecting piece.

Further, in the unit cell connecting device according to the first aspect or the second aspect of the present invention, it is preferable that the lead section of the outer connecting piece is formed in a step shape that projects outwardly. With the lead section formed in the step shape, when electric cell units are joined together, for example, only a limited space is formed between the lead sections facing each other so that the lead sections closely contact with each other. Accordingly, it is possible to securely fasten the lead sections, for example, with a fastening member. Here, if the lead section of the outer connecting piece does not protrude outwardly, there is an unavoidable space that is as large as a plate thickness of the inner connecting piece, so that it is difficult to securely contact the lead sections with each other.

Further, in the unit cell connecting device according to the first aspect or the second aspect of the present invention, the lead section may have a joining securing section to be securely joined to a joining securing section of the lead section disposed adjacently. Further, the lead section may have a joining securing section to be securely jointed to a wall section of a housing section of an electric cell. Accordingly, it is not necessary to separately provide a joining securing member or the like, thereby improving functionality of the unit cell connecting device.

According to a fourth aspect of the present invention, an assembled battery includes the unit cell connecting device for connecting the electric cells arranged vertically and horizontally in rows to form an electric cell unit. Accordingly, the assembled battery can provide the advantages described above. Especially, a plurality of electric cell units may be connected in a row and combined as an electric cell module to obtain the advantages described above.

According to a fifth aspect of the present invention, a method of manufacturing the assembled battery includes the steps of securing the electric cells with a tape; arranging the electric cells vertically in rows; preparing a combined component composed of a plurality of the inner connecting pieces and the outer connecting piece; and fixing the combined component to the anodes and cathodes of the electric cells arranged in rows by adhering (by spot welding and the like) to obtain an electric cell unit.

According to the fifth aspect of the present invention, the method of manufacturing the assembled battery may further include the step of connecting a plurality of the electric cell units in rows to obtain an electric cell module. Accordingly, it is possible to manufacture the electric cell unit or the electric cell module through a simple process.

### BRIEF DESCRIPTION OF THE DRAWINGS

FIG. 1 is a perspective view showing an electric cell unit used in an electric car as an assembled battery having a unit cell connecting device according to a first embodiment of the present invention;

FIG. 2 is a perspective view of a configuration of an electric cell module formed of electric cell units used in an electric car as an assembled battery having a unit cell connecting device according to a second embodiment of the present invention;

FIG. 3 is a perspective view showing an inner connecting piece of the unit cell connecting device according to the first embodiment of the present invention;

FIG. 4 is a perspective view showing an outer connecting piece of the unit cell connecting device according to the first embodiment of the present invention;

FIG. 5 is a perspective view showing an assembled component composed of the inner connecting pieces and the outer connecting piece according to the first embodiment of the present invention;

FIG. 6 is a perspective view showing an inner connecting piece of an unit cell connecting device according to a third embodiment of the present invention;

FIG. 7 is a perspective view showing an inner connecting piece of an unit cell connecting device according to a fourth embodiment of the present invention;

FIG. 8 is a perspective view showing a method of producing an electric cell group during a process of manufacturing the assembled battery according to the second embodiment of the present invention;

FIG. 9 is a perspective view showing a method of housing an electric cell module during the process of manufacturing the assembled battery according to the second embodiment of the present invention; and

FIG. 10 is a perspective view showing a configuration of a conventional assembled battery and a method of producing the conventional assembled battery.

### DETAILED DESCRIPTION OF PREFERRED EMBODIMENTS

Hereunder, embodiments of the present invention will be explained with reference to the accompanying drawings. In order to achieve high current resistance and enhanced heat dissipation so as to improve cooling capability and so on, an assembled battery is provided with an improved electrode connecting configuration and a lead section configuration upon forming the assembled battery.

### First Embodiment

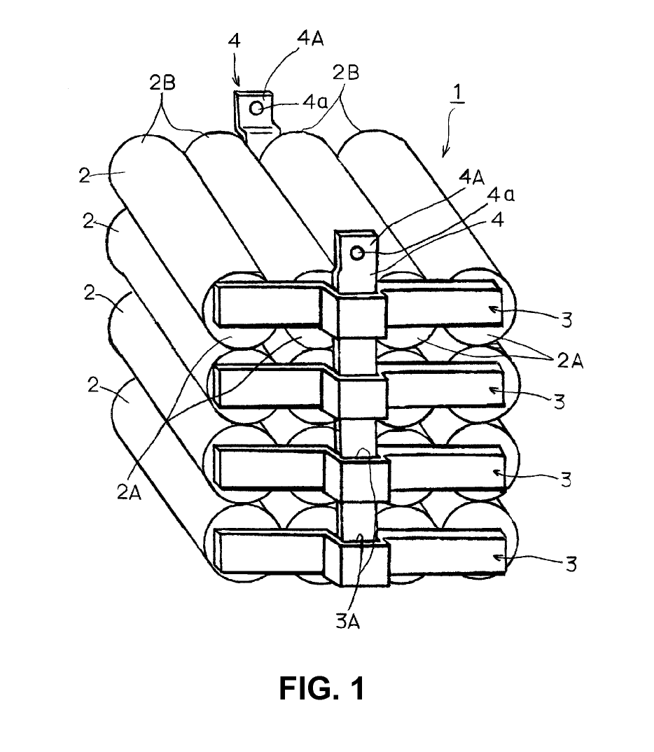

A first embodiment of the present invention will be described. FIG. 1 is a perspective view showing an electric cell unit 1 used in an electric car as an assembled battery having a unit cell connecting device according to a first embodiment of the present invention.

As shown in FIG. 1, the electric cell unit 1 is formed by connecting electric cells (or unit cells) using a unit cell connecting device of the first embodiment. More specifically, a plurality of electric cells 2 (sixteen electric cells in the embodiment) formed in a cylindrical shape is arranged and connected vertically and horizontally in a plurality of rows (four rows in the embodiment). The electric cells 2 have anodes 2A (positive electrodes 2A) and cathodes 2B (negative electrodes 2B) arranged on the same planes, respectively.

As shown in FIG. 1, the connecting device has a plurality of inner connecting pieces 3 (four inner connecting pieces in the embodiment) and at least one outer connecting piece 4 (one outer connecting piece in the embodiment). The inner connecting pieces 3 and the outer connecting piece 4 are provided corresponding to the anodes 2A and the cathodes 2B of the electric cells 2.

In the embodiment, the inner connecting pieces 3 and the outer connecting piece 4 are provided for connecting both the anodes 2A and the cathodes 2B. For this reason, only the inner connecting pieces 3 and the outer connecting piece 4 for connecting the anodes 2A will be described.

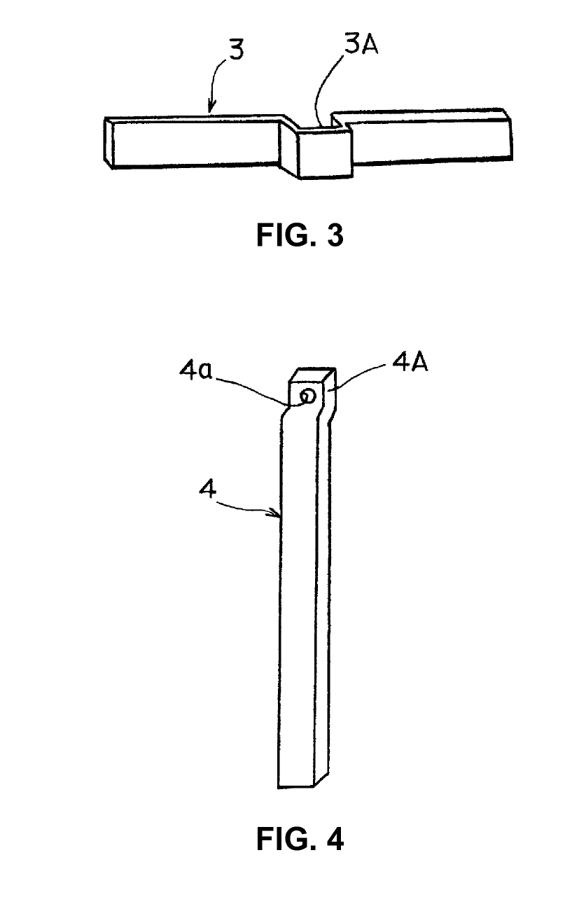

FIG. 3 is a perspective view showing the inner connecting piece 3 of the unit cell connecting device according to the first embodiment of the present invention. As shown in FIG. 3, the inner connecting piece 3 is formed in a rectangular flat strip shape and made of a conductive material, i.e., a metal such as nickel.

In the embodiment, a groove 3A with a square bottom U-character shape is formed at a center part of the inner connecting piece 3 along a longitudinal direction thereof for accommodating the outer connecting piece 4 therein. The groove 3A is situated at an inner part corresponding to a position between adjacent electric cells 2 (described later). When the groove 3A is formed, the center part of the inner connecting piece 3 is bent in the longitudinal direction to form a rectangular concave outer shape and a rectangular convex inside shape.

In the embodiment, the positive electrodes 2A (or the negative electrodes 2B), for example, four positive electrodes 2A of the electric cells 2 are arranged vertically or horizontally (horizontally in the embodiment) in each row, respectively, while the positive electrodes 2A are situated away from each other. Each of the inner connecting pieces 3 electrically connects adjacent positive electrodes 2A of the electric cells 2.

FIG. 4 is a perspective view showing the outer connecting piece 4 of the unit cell connecting device according to the first embodiment of the present invention. As shown in FIG. 4, the outer connecting piece 4 is formed in a rectangular flat strip shape and made of a conductive material such as copper. In addition, the outer connecting piece 4 is formed to have a thickness slightly larger than that of the inner connecting piece 3.

In the embodiment, a lead section 4A is formed to protrude outwardly at one end section of the outer connecting piece 4. The lead section 4A is provided as a joining and securing section for connecting a lead wire. The outer connecting piece 4 is formed in a step-like shape such that the lead section 4A slightly project outside. In addition, the lead section 4A has a round hole 4a as an opening thereof.

As described above, in the embodiment, the lead section 4A is provided as the joining and securing section. More specifically, the lead section 4A is provided as the joining and securing section for joining and securing a plurality of assembled batteries arranged adjacent to each other (an electric cell unit, described later). Further, the lead section 4A is provided as the joining and securing section for joining and securing the assembled batteries (an electric cell module, described later) to be housed in a housing section (a casing, described later) to a wall section of the housing section.

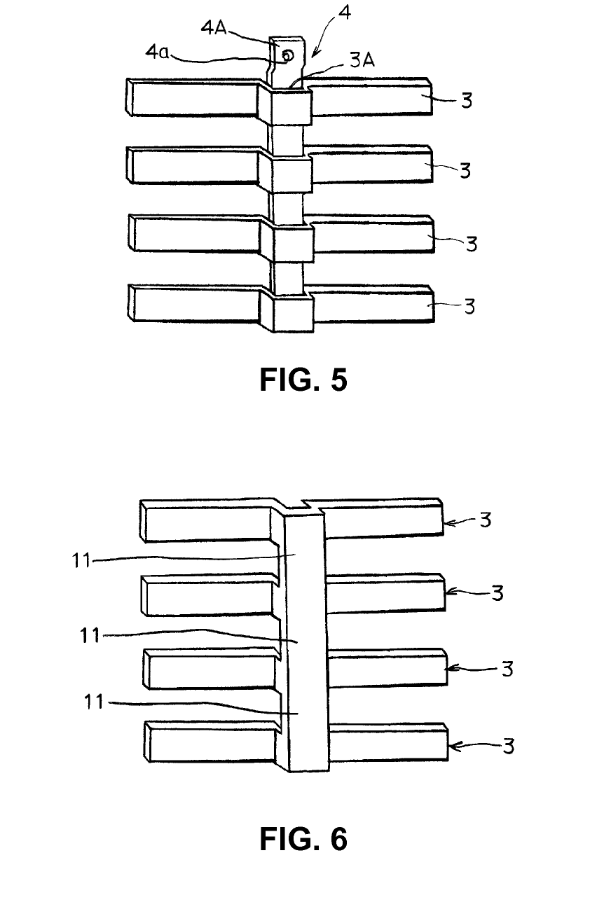

FIG. 5 is a perspective view showing an assembled component composed of the inner connecting pieces 3 and the outer connecting piece 4 according to the first embodiment of the present invention. As shown in FIG. 5, the outer connecting piece 4 is disposed in the grooves 3A of the four inner connecting pieces 3 and then securely fixed thereto by spot welding or the like, so that the inner connecting pieces 3 are electrically connected each other.

In the embodiment, the assembled component composed of the inner connecting pieces 3 and the outer connecting piece 4 shown in FIG. 5 is securely adhered to the anodes 2A and the cathodes 2B of the electric cells 2 by spot welding or the like as shown in FIG. 1. Thereafter, a lead wire (not illustrated) is connected to the lead section 4A protruding from upper sections of the both ends of the electric cells 2. Accordingly, the electric cell unit 1 as shown in FIG. 1 is formed, in which the electric cells 2 arranged vertically and horizontally in a plurality of rows are connected.

### Second Embodiment

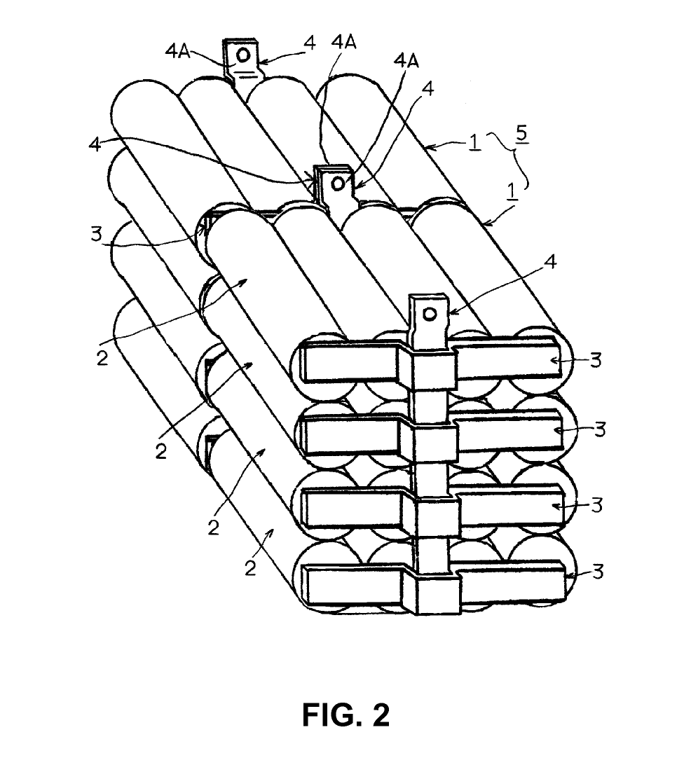

A second embodiment of the present invention will be described next. According to the second embodiment, as another configuration, it is possible to connect a plurality of the electric cell units 1. FIG. 2 is a perspective view of a configuration of an electric cell module 5 formed of the electric cell units 1 used in an electric car as an assembled battery having the unit cell connecting device according to the second embodiment of the present invention.

Next, a method of manufacturing the assembled battery will be described. FIG. 8 is a perspective view showing the method of producing an electric cell group during a process of manufacturing the assembled battery according to the second embodiment of the present invention.

First, as shown in FIG. 8, a plurality of the electric cells 2 (four electric cells 2 in the embodiment) are arranged horizontally in a row such that the anodes 2A and the cathodes 2B are positioned on the same planes, respectively. Then, the electric cells 2 are attached and securely adhered to each other with a double-side adhesive tape 6, thereby forming a plurality of electric cell groups 7 (four electric cell groups 7 in the embodiment).

Thereafter, the electric cell groups 7 are arranged (piled up) vertically in rows. In the embodiment, the double-sided tape 6 is used, so that the electric cell groups 7 are adhered (refer to FIG. 1).

Next, the outer connecting piece 4 is attached to the grooves 3A of the inner connecting pieces 3, and the outer connecting piece 4 and the inner connecting pieces 3 are securely adhered by the spot welding or the like. Through the procedure described above, two sets of the assembled components, each of which is formed of the four inner connecting pieces 3 and the outer connecting piece 4, are prepared. Thereafter, the assembled components are respectively welded and securely adhered to the anodes 2A and the cathodes 2B of the electric cell groups 7 arranged in a row by soldering or the like. Accordingly, the electric cell unit 1, in which a plurality of electric cells 2 is connected, is produced as shown in FIG. 1.

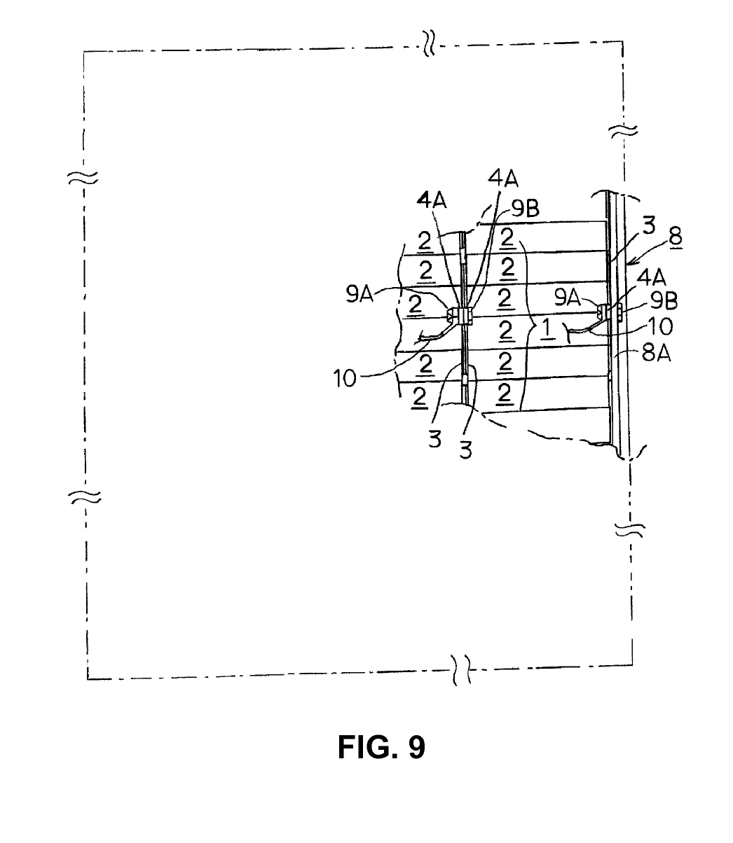

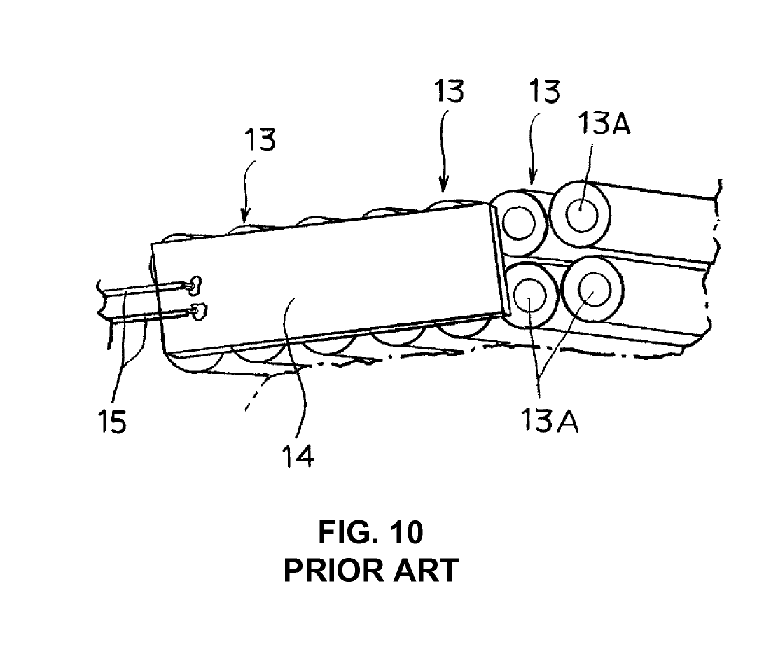

Furthermore, the electric cell units 1 are connected in a row, so that it is possible produce the electric cell module 5 shown in FIG. 2. In this case, the electric cell units 1 situated adjacently contact with each other while the lead sections 4A of the outer connecting pieces 4 face each other (refer to FIG. 2). Accordingly, the lead sections 4A can be connected together using fastening members such as bolts 9A or nuts 9B inserted in the round holes 4a of the lead sections 4A, so that it is possible to join and secure the adjacent electric cell units 1 (refer to FIG. 9).

In the embodiment, two electric cell units 1 are connected in the electric cell module 5 produced through the process described above. The present invention is not limited thereto. Alternatively, for example, it is also possible to provide the electric cell module 5 using a number of electric cell units 1. In this case, as shown in FIG. 9, the electric cell module 5 may be retained in a container main body 8 (a casing) as a housing section formed of an aluminum alloy, a resin, or the like.

FIG. 9 is a perspective view showing a method of housing the electric cell module 5 during the process of manufacturing the assembled battery according to the second embodiment of the present invention. As shown in FIG. 9, the lead sections 4A, which are provided at an end section of the electric cell units 1, are fastened to a wall section 8A of the container main body 8 with fastening members such as the bolts 9A or the nuts 9B. Accordingly, the electric cell module 5 is fixed and secured to the container main body 8. In addition, the lead sections 4A of the electric cell units 1 are connected to the lead wires 10 as necessary.

According to the first and the second embodiments, the unit cell connecting device includes a plurality of the inner connecting pieces 3 and the outer connecting piece 4 for connecting the inner connecting pieces 3. The unit cell connecting device is provided for connecting a plurality of the electric cells 2 arranged vertically and horizontally respectively in rows, and the anodes 2A and the cathodes 2B are aligned respectively on the same planes. In addition, the inner connecting pieces 3 are provided for electrically connecting the anodes 2A and the cathodes 2B of the electric cells 2.

Furthermore, the outer connecting piece 4 has the lead section 4A, which is formed at the end section of the outer connecting piece 4 so as to protrude outwardly. The outer connecting piece 4 has a thickness slightly larger than that of the inner connecting piece 3, and is provided for connecting the lead wires 10 (refer to FIG. 9). As a result, it is possible to obtain the unit cell connecting device that is resistant against a large current that flows in the electric cell unit 1 or the electric cell module 5 with a high capacity.

Moreover, in the first and the second embodiments, the lead sections 4A are provided for joining and securing the electric cell units 1 that are arranged in rows and adjacent to each other. Further, the lead sections 4A are provided for joining and securing the electric cell module 5 housed in the casing 8 to the wall section 8A of the casing 8. For this reason, it is possible to obtain the unit cell connecting device with superior functionality. Further, it is not necessary to separately provide a joining and securing member or the like.

In the first and the second embodiments, the grooves 3A are formed at the inner part of the inner connecting piece 3 corresponding to the positions between the adjacent electric cells 2 for accommodating the outer connecting piece 4 therein. As a result, it is possible to clearly define the position of the outer connecting piece 4 to be attached to the inner connecting pieces 3. Accordingly, it is easier to position the outer connecting piece 4 and tentatively attach the outer connecting piece 4 to the inner connecting pieces 3 before the outer connecting piece 4 is attached to the inner connecting pieces 3. Therefore, it is possible to securely attach the outer connecting piece 4 to the inner connecting pieces 3.

In the first and the second embodiments, the spaces are respectively formed between the inner connecting pieces 3, and the spaces between the electric cells 1 arranged horizontally and vertically adjacent to each other are opened outside. Accordingly, it is possible to easily obtain an air flow therein. In other words, it is possible to improve ventilation and enhance heat dissipation, so that it is possible to efficiently dissipate heat generated within the assembled electric battery and improve the cooling capability.

In the first and the second embodiments, the lead sections 4A of the outer connecting pieces 4 are formed in the step-like shape to slightly project outwardly. Accordingly, when the electric cell units 1 are connected to each other, no space corresponding to the thickness of the inner connecting pieces 3 is formed between the lead sections 4A that face each other, so that the lead sections 4A can securely contact each other. For this reason, the lead sections 4A can be securely fastened with the fastening member. If the lead sections 4A of the outer connecting pieces 4 are formed in a straight shape, a space corresponding to the thickness of the inner connecting pieces 3 is formed between the lead sections 4A that face each other. In this case, it is difficult to securely contact the lead sections 4A each other.

In the first and the second embodiments, when the electric cell unit 1 and the electric cell module 5 are manufactured, the electric cells 2 are adhered and secured with a double-sided tape 6 to form the electric cell groups 7, and the electric cell groups 7 are arranged and adhered to each other vertically in rows. Then, the assembled component of the inner connecting pieces 3 and the outer connecting piece 4 is securely adhered to the anodes 2A and the cathodes 2B of the electric cell groups 7 in rows respectively by spot welding or the like, thereby obtaining the electric cell unit 1. In addition, the electric cell units 1 are connected in a plurality of rows to produce the electric cell module 5. Therefore, it is possible to easily manufacture the electric cell unit 1 and the electric cell module 5.

### Third Embodiment

A third embodiment of the present invention will be described next. In the third embodiment, the inner connecting pieces 3 may be configured as described below. FIG. 6 is a perspective view showing the inner connecting piece 3 of the unit cell connecting device according to the third embodiment of the present invention.

As shown in FIG. 6, the inner connecting pieces 3 are joined with flat bridge sections 11 that extend along the adhering positions of the outer connecting pieces 4. Accordingly, it is possible to integrally form the inner connecting pieces 3 and the bridge section 11 as one piece. In this case, the inner connecting piece 3 may be formed through a press work so as to punch one sheet member into a specific shape.

In the third embodiment, the inner connecting pieces 3 has the integrated configuration described above similarly to the inner connecting pieces 3 in the first and second embodiments. Accordingly, it is possible to the unit cell connecting device that can resist against a large current and improve the cooling capability. In addition, it is not necessary to make a plurality of strip-like inner connecting pieces, so that it is possible to reduce the number of the components. Moreover, as opposed to the unit cell connecting device, in which a plurality of strip-like inner connecting pieces 3 is arranged, it is not necessary to individually attach the inner connecting pieces 3 to the outer connecting pieces 4 one by one. Further, it is not necessary to individually position the inner connecting pieces 3, thereby improving productivity.

### Fourth Embodiment

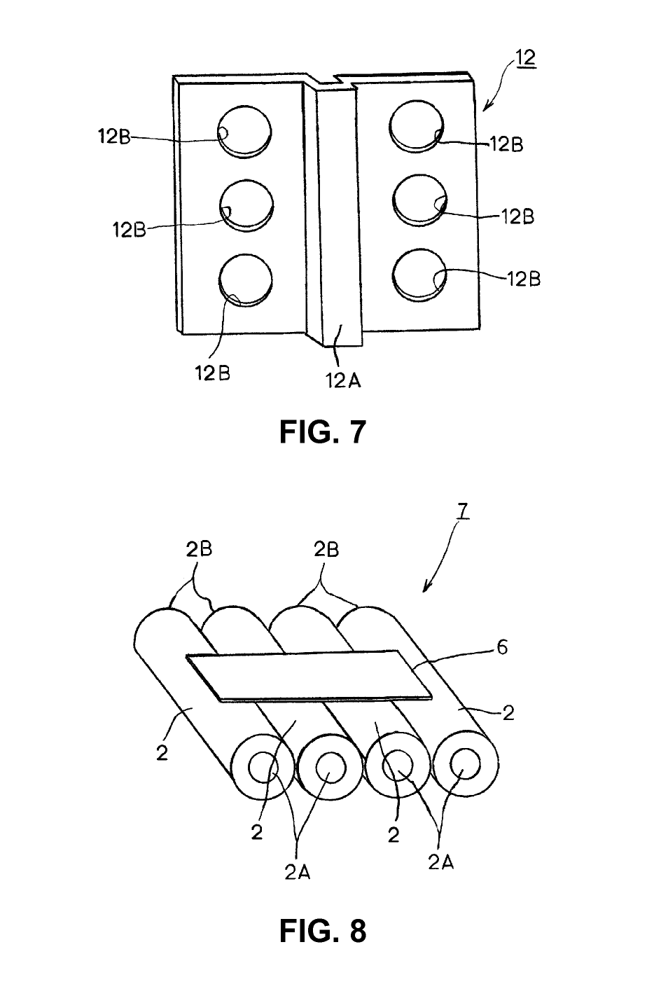

A fourth embodiment of the present invention will be described next. In the fourth embodiment, the inner connecting piece 3 may be formed of a substantially rectangular single sheet member. FIG. 7 is a perspective view showing an inner connecting piece 12 of the unit cell connecting device according to the fourth embodiment of the present invention.

As shown in FIG. 7, the inner connecting piece 12 is formed in a flat rectangular single plate member having a large area. A groove 12A is formed in the inner connecting piece 12 at a center portion thereof between two adjacent electric cells 2 for accommodating the outer connecting piece 4 therein.

In the fourth embodiment, the inner connecting piece 12 has openings, for example, a plurality of round ventilation holes 12B, which are respectively opened on the both sides of the groove 12A at positions corresponding to the spaces between the adjacent electric cells 2 arranged vertically and horizontally. In this case, the inner connecting piece 12 may be formed with a press work so as to punch one sheet member into the specific shape.

Similarly to the inner connecting pieces 3 in the first and second embodiments, with the inner connecting piece 12, it is possible to obtain the unit cell connecting device that can resist against a large current and improve the cooling capability, thereby improving productivity. In addition, the inner connecting piece 12 is simply formed in the single sheet member having the ventilation holes 12B formed therein. Accordingly, it is possible to enhance the strength of the inner connecting piece 12. When the inner connecting piece 12 having the configuration described above is applied to the unit cell connecting device, an electric cell unit and an electric cell module can be produced through a method similar to that in the second embodiment with superior productivity.

In the first to fourth embodiments, only one outer connecting piece 4 is provided at the center part in the lateral direction, and the number and position of the outer connecting piece 4 are not limited to the embodiments. In addition, in the first to fourth embodiments, the electric cells 2 with the cylindrical shape are suitably used in an electric car. Alternatively, it is possible to form the electric cells 2 in a different shape and type. While the invention may be advantageously applied to the high-capacity electric cell modules that are used in electric cars, it is also possible to apply the invention in other electric products other than electric cars.

While the invention has been explained with reference to the specific embodiments of the invention, the explanation is illustrative and the invention is limited only by the appended claims.

What is claimed is:

1. A unit cell connecting device for connecting a plurality of unit cells arranged vertically and horizontally in rows so that electrodes thereof are aligned on a same plane, comprising:
a plurality of inner connecting pieces for connecting the electrodes of the unit cells; and
at least one outer connecting piece attached to the inner connecting pieces for connecting the inner connecting pieces,
wherein said at least one outer connecting piece includes a lead section formed at one end section thereof so as to protrude outwardly for connecting a lead wire.

2. The unit cell connecting device according to claim 1, wherein said inner connecting pieces are integrated together through a bridging piece extending along the at least one outer connecting piece.

3. A unit cell connecting device for electrically connecting a plurality of unit cells arranged vertically and horizontally in rows so that electrodes thereof are aligned on a same plane, comprising:
at least one inner connecting piece for connecting the electrodes of the unit cells; and
at least one outer connecting piece electrically connected to the at least one inner connecting piece,
wherein said at least one inner connecting piece includes a ventilation hole at a position between the unit cells, and
said at least one outer connecting piece includes a lead section formed at one end section thereof so as to protrude outwardly for electrically connecting a lead wire.

4. The unit cell connecting device according to claim 1, wherein each of said inner connecting pieces includes a groove portion for accommodating the at least one outer connecting piece.

5. The unit cell connecting device according to claim 1, wherein said lead section is formed in a step shape.

6. The unit cell connecting device according to claim 1, wherein said lead section is configured to connect another lead section, or to be fixed to a container.

7. An assembled battery comprising the unit cells arranged to form a battery unit and the unit cell connecting device according to claim 1.

8. The assembled battery according to claim 7, wherein said battery unit is connected to another battery unit to form a battery module.

9. A method of producing the assembled battery according to claim 7, comprising the steps of:
arranging the electric cells horizontally in a row;
securing the electric cells with a tape;
arranging the electric cells vertically in rows;
preparing a combined component formed of the inner connecting pieces and the at least one outer connecting piece; and
fixing the combined component to the electrodes to obtain a battery unit of the assembled battery.

10. The method of producing the assembled battery according to claim 9, further comprising the steps of:
arranging a plurality of battery units;
aligning the lead sections to face each other; and
connecting the lead sections to form a battery module.
